(19) United States
(12) Patent Application Publication
(10) Pub. No.: US 2015/0236806 A1
(43) Pub. Date: Aug. 20, 2015

(54) METHOD FOR SHARING AND PLAYING MULTIMEDIA CONTENT AND ELECTRONIC DEVICE IMPLEMENTING THE SAME

(71) Applicant: Samsung Electronics Co., Ltd., Suwon-si (KR)

(72) Inventor: Jeongseob KIM, Daegu (KR)

(21) Appl. No.: 14/604,074

(22) Filed: Jan. 23, 2015

(30) Foreign Application Priority Data
Feb. 17, 2014 (KR) 10-2014-0017797

(51) Int. Cl. H04H 20/88; H04H 60/92; H04H 20/18

(52) U.S. Cl. CPC H04H 20/88; H04H 20/18; H04H 60/92

(57) ABSTRACT

A playing method for an electronic device is provided. The method includes playing multimedia content including audio, receiving characteristic information from an external device, comparing the received characteristic information with characteristic information of the audio of the multimedia content, determining whether to perform a sharing play of the multimedia content based on a result of the comparing of the received characteristic information, and transmitting at least one portion of the multimedia content to the external device upon determining to perform the sharing play of the multimedia content.

### CROSS-REFERENCE TO RELATED APPLICATION(S)

This application claims the benefit under 35 U.S.C. §119(a) of a Korean patent application filed on Feb. 17, 2014 in the Korean Intellectual Property Office and assigned Serial number 10-2014-0017797, the entire disclosure of which is hereby incorporated by reference.

### TECHNICAL FIELD

The present disclosure relates to a method for sharing and playing a multimedia content between a plurality of electronic devices, and an electronic device implementing the same.

### BACKGROUND

Recently, an electronic device, such as a smart phone, a mobile phone, and the like, may share a multimedia content with an adjacent other electronic device by using a short-range wireless communication technology, e.g., Wi-Fi, near field communication (NFC), or the like. In addition, the electronic device may play the shared multi-media content simultaneously with other electronic device.

According to the method for sharing and playing a multimedia content, first, a connection between devices by a control operation of user is required. If a connection between two or more devices is established, the user selects a share target multimedia content from a multimedia content list. The electronic device, e.g., the electronic device determined to be a master in the connection process, may play the multimedia content selected by the user while transmitting to other electronic device. Other electronic device may play the received multimedia content. Accordingly, the same multimedia content is played through a plurality of electronic devices. Meanwhile, if the audio provided by the multimedia content is stereo audio, the user may select an audio channel for playing according to each electronic device. For example, a master electronic device may play the audio of a first channel and transmit the audio of a second channel to a client electronic device in response to user's selection. A client electronic device may play the received audio of second channel.

However, according to the method for sharing and playing a multimedia content, it is disadvantageous in that the control operation of user should be required. In addition, it is disadvantageous in that the user should directly select a sharing target. Furthermore, when the audio provided by the multimedia content is stereo audio, it is disadvantageous in that the user should assign the audio channel for playing according to each electronic device.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a method for playing a multimedia content between a plurality of electronic devices, and an electronic device implementing the same.

In accordance with an aspect of the present disclosure, a playing method for an electronic device includes playing multimedia content including audio, receiving characteristic information from an external device, comparing the received characteristic information with characteristic information of an audio of the multimedia content, determining whether to perform a sharing play of the multimedia content based on a result of the comparing of the received characteristic information, and transmitting at least one portion of the multimedia content to the external device upon determining to perform the sharing play of the multimedia content.

In accordance with another aspect of the present disclosure, a playing method for an electronic device includes receiving audio through the microphone, transmitting a sharing play request message including characteristic information of the received audio to a first external device, receiving multimedia content related with the received audio from the first external device in response to the sharing play request message, and playing the received multimedia content.

In accordance with another aspect of the present disclosure, an electronic device is provided. The electronic device includes at least one speaker, an audio processing unit configured to convert a digital audio into an analog audio and to output the analog audio to the at least one speaker, at least one processor configured to control the at least one speaker and the audio processing unit so as to play the digital audio, and a data transmission and reception module configured to perform data communication with an external device, wherein the at least one processor is further configured to compare received characteristic information that is received from the external device with characteristic information of audio of multimedia content being played through the at least one speaker, determine whether to perform a sharing play of the multimedia content based on a result of the comparing of the received characteristic information, and transmit at least one portion of the multimedia content to the external device upon determining to perform the sharing play of the multimedia content.

In accordance with another aspect of the present disclosure, an electronic device is provided. The electronic device includes at least one speaker, a microphone, an audio processing unit configured to convert a digital audio into an analog audio, to output the analog audio to the at least one speaker, and to convert the analog audio received from the microphone into a digital audio, at least one processor configured to control the at least one speaker and the audio processing unit, and a data transmission and reception module configured to perform data communication with an external device, wherein the at least one processor is further configured to transmit a sharing play request message including characteristic information of an audio received through the microphone and the audio processing unit to the external device by using the data transmission and reception module, and play received multimedia content, from the external device, as a response to the sharing play request message.

In accordance with another aspect of the present disclosure, a computer readable recording medium storing a program for playing multimedia content in an electronic device is provided. The program performing playing multimedia content, receiving characteristic information from an external device, comparing the received characteristic information with characteristic information of audio of the multimedia content, determining whether to perform a sharing play of the multimedia content based on a result of the comparing of the received characteristic information, and transmitting at least one portion of the multimedia content to the external device when it is determined to perform the sharing play of the multimedia content.

Various embodiments of the present disclosure may provide a method for sharing and playing a multimedia content between a plurality of electronic devices compared to related art.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a front view of an electronic device including a mono speaker according to an embodiment of the present disclosure;

FIG. 2 is a front view of an electronic device including a stereo speaker according to an embodiment of the present disclosure;

FIG. 3 is a block diagram of an electronic device according to an embodiment of the present disclosure;

FIG. 4 is a block diagram of a multimedia content sharing play system according to an embodiment of the present disclosure;

FIG. 5 is a flowchart for explaining a method for sharing and playing multimedia content according to an embodiment of the present disclosure;

FIG. 6 is a diagram for explaining a method for sharing and playing multimedia content in a situation in which clients are respectively disposed on either side of a master according to an embodiment of the present disclosure;

FIG. 7 is a diagram for explaining a process of determining a degree of similarity for a left channel and a right channel of a stereo audio according to an embodiment of the present disclosure;

FIG. 8 is a diagram for explaining a method for sharing and playing multimedia content in a situation in which a single client is disposed in a left side of a master according to an embodiment of the present disclosure;

FIG. 9 is a diagram for explaining a method for sharing and playing multimedia content in a situation in which two clients are disposed in a right side of a master according to an embodiment of the present disclosure;

FIG. 10 is a flowchart for explaining a method for sharing and playing multimedia content according to various embodiments of the present disclosure; and

FIG. 11 is a flowchart for explaining a method for sharing and playing multimedia content according to various embodiments of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The expressions such as “include” and “may include” which may be used in various embodiments of the present disclosure denote the presence of the disclosed functions, operations, and constituent elements and do not limit one or more additional functions, operations, and constituent elements. In various embodiments of the present disclosure, the terms such as “include” or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof

Furthermore, in various embodiments of the present disclosure, the expression “and/or” includes any and all combinations of the associated listed words. For example, the expression “A and/or B” may include A, may include B, or may include both A and B.

In various embodiments of the present disclosure, expressions including ordinal numbers, such as “first” and “second,” or the like, may modify various elements. However, such elements are not limited by the above expressions. For example, the above expressions do not limit the sequence and/or importance of the elements. The above expressions are used merely for the purpose to distinguish an element from the other elements. For example, a first user device and a second user device indicate different user devices although both of them the first user device and the second user device are user devices. For example, a first element could be termed a second element, and similarly, a second element could be also termed a first element without departing from the scope of various embodiments of the present disclosure.

In the case where according to which a component is referred to as being “connected” or “accessed” to other component, it should be understood that not only the component is directly connected or accessed to the other component, but also there may exist another component between them the component and the other component. Meanwhile, in the case where according to which a component is referred to as being “directly connected” or “directly accessed” to other component, it should be understood that there is no component therebetween.

The terms used in various embodiments of the present disclosure are only used to describe specific various embodiments, and are not intended to limit various embodiments of the present disclosure.

Unless defined otherwise, the terms including technical and scientific terms used in this specification may have the meaning that can be commonly apprehended by those skilled in the art. The terms, such as the terms defined in the commonly-used dictionary, must be interpreted based on the context of the related technology and must not be interpreted ideally or excessively unless obviously defined otherwise in various embodiments of the present disclosure.

Detailed descriptions of well-known functions and structures incorporated herein may be omitted to avoid obscuring the subject matter of the present disclosure. In the various embodiments, some parts may be omitted if technical content which is already known to a person of ordinary skill in the art but are not related to the technical subject matter.

An electronic device according to the present disclosure may be a device including a communication function. For example, the device may include at least one of a smartphone, a tablet personal computer (PC), a mobile phone, a video phone, an e-book reader, a desktop PC, a laptop PC, a netbook computer, a personal digital assistant (PDA), a portable multimedia player (PMP), a Motion Pictures Experts Group (MPEG) audio layer 3 (MP3) player, a mobile medical device, a camera, or a wearable device, e.g., a head-mounted-device (HMD) such as electronic glasses, an electronic garment, an electronic bracelet, an electronic necklace, an electronic accessory, an electronic tattoo, or a smart watch.

According to various embodiments of the present disclosure, an electronic device may be a smart home appliance including a communication function. For example, the smart home appliance may include at least one of a television (TV), a digital video disk (DVD) player, an audio device, a refrigerator, an air-conditioner, vacuum, an oven, a microwave, a washing machine, an air cleaner, a set-top box, a TV box, e.g., Samsung HomeSync™, Apple TV™, or Google TV™, game consoles, an electronic dictionary, an electronic key, a camcorder, or an electronic frame.

According to various embodiments of the present disclosure, an electronic device may include at least one of various medical devices, e.g., an magnetic resonance angiography (MRA) device, a magnetic resonance imaging (MRI) device, a computed tomography (CT) device, a scanning machine, an ultrasonic wave device, and the like, a navigation device, a global positioning system (GPS) receiver, an event data recorder (EDR), a flight data recorder (FDR), vehicle infotainment device, an electronic equipment for a ship, e.g., navigation equipment for a ship, a gyrocompass, or the like, avionics, a security device, a vehicle head unit, an industrial or household robot, an automatic teller machine (ATM) of financial institution, or a point of sales (POS) device of a store.

According to various embodiments of the present disclosure, an electronic device may include at least one of furniture or a portion of a building/structure that includes a communication function, an electronic board, an electronic signature receiving device, a projector, or various measuring instruments, e.g., water, electricity, gas, or electric wave measuring equipment, and the like. An electronic device according to the present disclosure may be a combination of at least one of the aforementioned various devices. In addition, an electronic device according to the present disclosure may be a flexible device. In addition, it is obvious to those skilled in the art that the electronic device according to the present disclosure is not limited to the aforementioned devices.

It is obvious to those skilled in the art that the electronic device according to various embodiments of the present disclosure is not limited to the aforementioned devices. The term user used in various embodiments of the present disclosure may refer to a person who uses an electronic device or a device, e.g., an artificial intelligence electronic device, that uses an electronic device.

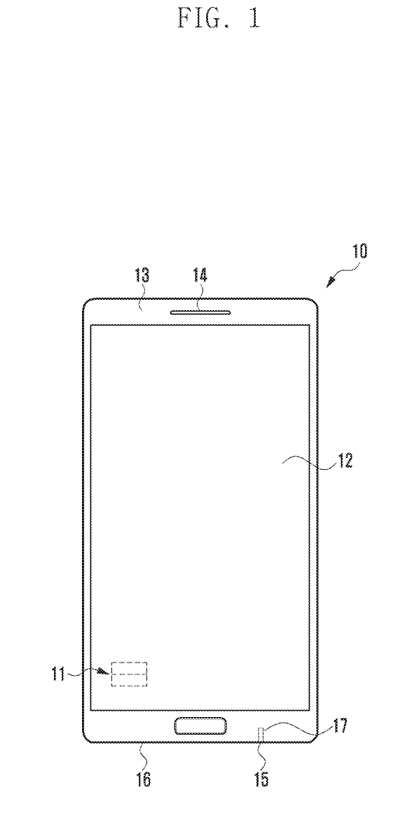

FIG. 1 is a front view of an electronic device including a mono speaker according to an embodiment of the present disclosure.

Referring to FIG. 1, the electronic device, which may be a smart phone 10, may be equipped with a mono speaker 11, which may also be referred to as a loud speaker 11. A hole for emitting an audio, such as an audio sound based on music play or video play, or an incoming call voice, outputted from the loud speaker 11 to the outside may be formed in a rear surface of the smart phone 10. In this case, the rear surface may be a surface in which a battery cover of the smart phone 10 is disposed. A front surface may relatively be a surface in which a screen 12, which may also be referred to as a touch screen 12, is formed. The smart phone 10 may be equipped with a receiver (not shown) for receiving and outputting the incoming call voice. In addition, a hole 14 for emitting a voice which is outputted from the receiver to the outside may be formed on a front top 13 of the smart phone 10. In addition, the smart phone 10 may be equipped with a microphone 15. In addition, a microphone hole 17 for enabling the microphone 15 to receive a sound from outside may be formed in a side of bottom 16 of the smart phone 10.

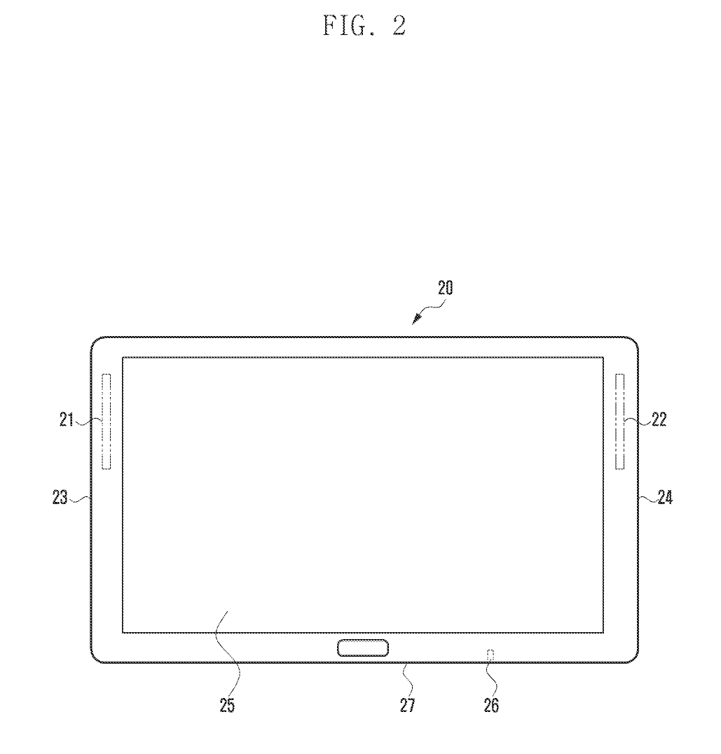

FIG. 2 is a front view of an electronic device including a stereo speaker according to an embodiment of the present disclosure.

Referring to FIG. 2, the electronic device, which may be a tablet PC 20, may be equipped with a stereo speaker set including a left loud speaker 21 and a right loud speaker 22. In addition, a speaker hole (not shown) for emitting the audio outputted from the left loud speaker 21 to the outside may be formed in a left side 23 of the tablet PC 20. Another speaker hole (not shown) for emitting the audio outputted from the right loud speaker 22 to the outside may be formed in a right side 24 of the tablet PC 20. Obviously, the speaker holes may be formed in the left and right sides of a front surface of the tablet PC 20 in which a screen 25 is disposed. The tablet PC 20 may be equipped with a microphone 26. In addition, a microphone hole (not shown) for enabling the microphone 26 to receive a sound from outside may be formed in a bottom side 27 of the tablet PC 20. Obviously, the microphone hole may be formed in a lower portion of the front surface of the tablet PC 20.

The smart phone 10 and the tablet PC 20 may be respectively equipped with a communication module for a wireless data communication, e.g., transmission and reception of a multimedia content and its characteristic information, with another electronic device.

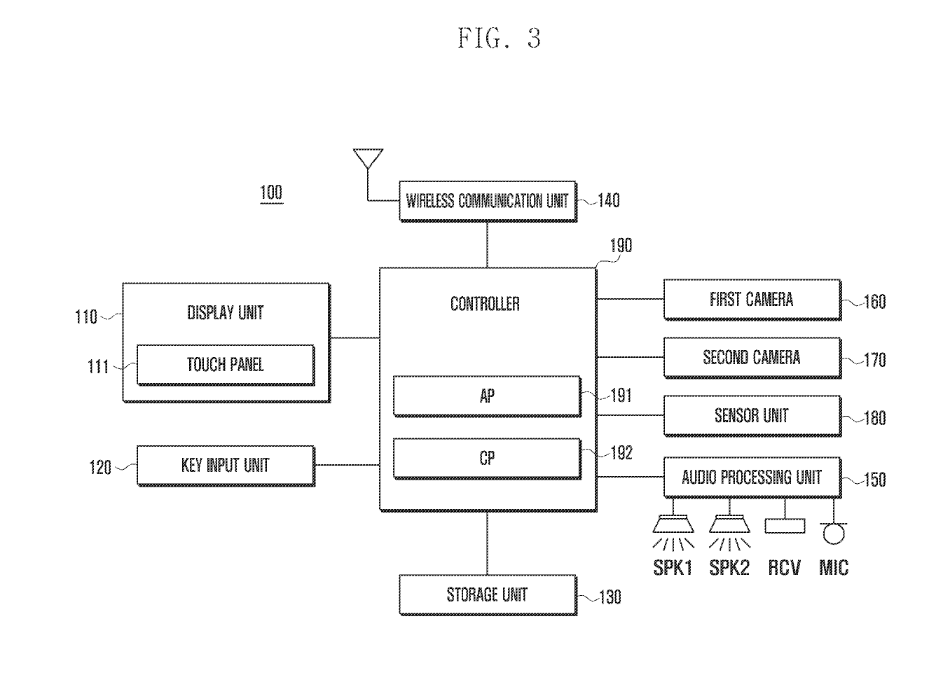

FIG. 3 is a block diagram of an electronic device according to an embodiment of the present disclosure.

Referring to FIG. 3, an electronic device 100, according to an embodiment of the present disclosure, may include a display unit 110, a key input unit 120, a storage unit 130, a wireless communication unit 140, an audio processing unit 150, a first speaker SPK 1, a second speaker SPK 2, a microphone MIC, a receiver RCV, a first camera 160, a second camera 170, a sensor unit 180, and a controller 190.

The display unit 110 may display data on a screen under the control of the controller 190. That is, when the controller 190 processes, e.g., decodes, resizes, or performs other operations on the data to store the data in a memory, e.g., an internal memory (not shown) of the display unit 110 or the storage unit 130, the display unit 110 may display the data stored in the memory on the screen. The display unit 110 may include a panel (not shown) and/or a hologram device (not shown). The panel may be, for example, a liquid crystal display (LCD), and an active matrix organic light emitting diode (AM-OLED) display, or the like. The panel may be implemented, for example, to be flexible, transparent, and/or wearable. The panel may be implemented by the same module of a touch panel 111. The hologram device may display a three-dimensional image in the air by using interference of light. The display unit 110 may further include a control circuit (not shown) for controlling the panel or the hologram device.

The touch panel 111 may be installed in the display unit 110. For example, the touch panel 111 may be implemented by an add-on type which is located on the display unit 110, or an on-cell type or an in-cell type which is inserted in the display unit 110.

The touch panel 111 may be, for example, a capacitive type, a resistive type, an infrared type and/or ultrasound type system of at least one way to detect a user input, for example, a share read command, and generates an event corresponding to user input that may be passed to the controller 190. The touch panel 111 may recognize the user input, e.g., a sharing play command, in at least one of, for example, a capacitive type, a resistive type, an infrared type, or an ultrasonic wave type, and generate an event corresponding to the user input to deliver to the controller 190. Further, the touch panel 111 may further include a controller (not shown). The controller, for example, may determine a representative coordinate among touch coordinates in the recognized touch input, and may deliver the representative touch coordinate to the controller 190. Obviously, such a control may be performed by the controller 190.

For example, in the case of the capacitive type, the touch panel 111 may recognize an indirect touch as well as a direct touch. A direct touch method may be a method of directly contacting the touch panel 111 by a conductive material, e.g., a finger or a stylus. According to an embodiment of the present disclosure, an indirect touch method may be a method of approaching the touch panel 111 by a conductive material, surrounded by a non-conductive material, e.g., a gloved finger, or a method of directly contacting the touch screen by the non-conductive material, e.g., a glove to which a finger is inserted. According to another embodiment of the present disclosure, the indirect touch method may be a method of contacting the non-conductive material by a finger in a state where the non-conductive material, e.g., a cover for protecting the touch panel 111, contacts the touch panel 111. According to another embodiment of the present disclosure, the indirect touch method may be a method of generating an event, which may be referred to as hovering, as the finger approaches the touch screen within a specified distance while the finger is not in contact with the touch panel 111. The touch panel 111 may further include a tactile layer. In this case, touch panel 111 may provide a tactile response to the user.

The key input unit 120 may include at least one touch key (not shown). Such a touch key may refer to all types of input devices, units, and elements, to recognize a touch input or an approach of a human body part and/or an object. The key input unit 120 may generate an event in response to a user input, e.g., a sharing play command, and may deliver the event to the controller 190. The key input unit 120 may further include a different type of key (not shown) in addition to the touch type. For example, the key input unit 120 may include at least one dome key. When the user presses down the dome key, the dome key is deformed and contacts a printed circuit board. Accordingly, a key event may be generated in the printed circuit board and may be transmitted to the controller 190. Meanwhile, the key provided in the key input unit 120 may be referred to as a hard key. A soft key, a menu or an icon corresponding to the hard key may be displayed on the screen.

The storage unit 130 may store, under the control of the controller 190, data generated by the electronic device 100 or received from an external device, e.g., a server, a desktop PC, a tablet PC, etc., through the wireless communication unit 140. In addition, the storage unit 130 may store a boot program, at least one or more operating systems and applications. In addition, the storage unit 130 may store various setting information, e.g., a brightness level of screen, a vibration in the event of touch, and an automatic rotation of screen, for setting a use environment of electronic device 100. Accordingly, the controller 190 may operate the electronic device 100 with reference to the setting information.

The storage unit 130 may include a main memory (not shown) and a secondary memory (not shown). The main memory may be implemented, for example, by a random access memory (RAM). The secondary memory may be implemented by a disk, RAM, a read-only memory (ROM), a flash memory, or the like. The main memory may store various programs, for example, a boot program, an operating system and applications, loaded from the secondary memory. If a power of a battery is supplied to the controller 190, first, the boot program may be loaded into the main memory. The boot program may load the operating system into the main memory. The operating system may load the application into the main memory. The controller 190, which includes an application processor (AP) 191, may access the main memory and decode a command, and/or a routine of a program, and may execute a function corresponding to the decoding result. That is, various programs may be loaded into the main memory and operate as a process.

The storage unit 130 may further include an external memory (not shown). For example, the storage unit 130 may include a compact flash (CF), a secure digital (SD), a micro secure digital (micro-SD), a mini secure digital (mini-SD), an extreme digital (xD), a memory stick, or the like, as the external memory.

In particular, the storage unit 130 may store a multimedia content playing and sharing program. The multimedia content playing and sharing program may be classified into a program for a master, e.g. a master electronic device, and a program for a client, e.g., a client electronic device. The program for the master may be configured to enable the electronic device 100 to perform an operation of playing a multimedia content, an operation of receiving characteristic information of the multimedia content from the client electronic device, an operation of calculating the degree of similarity between the characteristic information of the received multimedia content and the characteristic information of the playing multimedia content, an operation of determining the sharing play by analyzing the degree of similarity, and an operation of transmitting the multimedia content being played to the client electronic device when the sharing play is determined. The program for the client electronic device may be configured to enable the electronic device 100 to perform an operation of controlling to operate the microphone in response to a sharing play request from a user, an operation of sampling, for example, extracting characteristic information, e.g., a frequency, a waveform, a wave height, an acoustic fingerprint and/or an audio fingerprint, and the like, of the received audio, the audio received from the microphone.

The wireless communication unit 140 may perform a voice call, a video call or a data communication with an external device via a network under the control of the controller 190. The wireless communication unit 140 may include a radio frequency transmitter for up-converting and amplifying a frequency of a transmitted signal, and a radio frequency receiver for low-noise amplifying and down-converting the frequency of the received signal. In addition, the wireless communication unit 140 may include a mobile communication module, e.g., a 3^{rd}-Generation mobile communication module, a 3.5-Generation mobile communication module, a 4^{th}-Generation mobile communication module, or the like, a digital broadcast module, e.g., a digital multimedia broadcasting (DMB) module, and a short range communication module, e.g., a Wi-Fi module, a Bluetooth (BT) module, and a near field communication (NFC) module.

The audio processing unit 150 may perform an input and output of audio signal, e.g., voice data, for a voice recognition, a voice recording, a digital recording, and a call, in combination with the receiver RCV, the first speaker SPK 1, the second speaker SPK 2, and the microphone MIC. The audio processing unit 150 may receive the audio signal from the controller 190, and perform a digital to analog (D/A) conversion of the received audio signal to convert into an analog, and then amplify the converted signal to output to the receiver RCV, the first speaker SPK 1, or the second speaker SPK 2. The audio processing unit 150 may perform an analog to digital (A/D) conversion of the audio signal received from the microphone MIC and then provide to the controller 190. The receiver RCV, the first speaker SPK 1, and the second speaker SPK 2 may convert and output the audio signal received from the audio processing unit 150 into a sound wave. The microphone MIC may convert the sound wave delivered from a person or other sound sources into an audio signal.

The first camera 160 and the second camera 170 may perform a function for photographing a subject to output image data to the controller 190 under the control of the controller 190. In more detail, the first camera 160 and the second camera 170 may include, respectively, a lens for collecting light, an image sensor for converting the light into an electrical signal, and an image signal processor (ISP) for processing the electrical signal input from the image sensor as a raw data and outputting the processed raw data to the controller 190. In this case, the ISP, under the control of the controller 190, may process the raw data into a preview image and output to the controller 190. Then, the controller 190 may control the display 110 to display the preview image on the screen. Further, the ISP, under the control of the controller 190, may process the raw data into a compression image, e.g., a Joint Photographic Experts Group (JPEG) image, and output the compression image to the controller 190. The controller 190 may detect a shutter event, for example a user taps the shutter button displayed on the display 110, from the touch panel 111 or the key input unit 120, and may store the compression image into the storage unit 130 in response to the shutter event. Camera holes of the first camera 160 and the second camera 170 may be formed respectively on the front surface and the rear surface. Alternatively, the camera holes of the first camera 160 and the second camera 170 may be formed on a same surface.

The sensor unit 180 may detect a physical quantity, e.g., an acceleration, a pressure, a light intensity, etc., and/or its change, and may generate detection information, e.g., a voltage change amount (Av), to deliver to the controller 190. In addition, the sensor unit 180 may detect an operation and/or operating state, e.g., motion, of the electronic device 100, and may generate detection information to be delivered to the controller 190.

The sensor unit 180 may include, although not shown, for example, at least one of a gesture sensor, a gyro sensor, a pressure sensor, a magnetic sensor, an acceleration sensor, a grip sensor, a proximity sensor, a red green blue (RGB) sensor, a biometric sensor, a temperature/humidity sensor, an illuminance sensor, and/or an ultra violet (UV) sensor. Furthermore, the sensor unit 180 may further include, for example, an E-nose sensor (not shown), an electromyography (EMG) sensor (not shown), an electroencephalogram sensor (EEG) sensor (not shown), an electrocardiogram sensor (ECG) sensor (not shown), and/or a fingerprint sensor (not shown). The sensor unit 180 may further include a control circuit for controlling at least one sensor which belongs to the sensor unit 180. The sensors belonging to the sensor unit 180 may be integrated in a single chip, or implemented in separate chips respectively.

The controller 190 may control the overall operation of the electronic device 100 and a signal flow between the internal configurations, which may include hardware elements, of the electronic device 100, perform a data processing, and control the power supply from the battery to the configurations. In particular, the controller 190 may execute the above-mentioned multimedia content playing and sharing program.

The controller 190 may include one or more processors. For example, the controller 190 may include one or more AP 191, or one or more communications processor (CP) 192. The AP 191 and the CP 192 may be integrated into a single package composed of a single integrated circuit. Obviously, the AP 191 and the CP 192 may be included in a different package.

The AP 191 may operate an operating system or an application to control a plurality of hardware and/or software connected with the AP 191, and may perform various data processing and operations. The AP 191 may be implemented, for example, in a system on chip (SoC). According to an embodiment of the present disclosure, the controller 190 may further include a graphic processing unit (GPU) (not shown).

The CP 192 may perform a function for managing a data link used for communication between the electronic device 100 and other external devices connected through the network, and converting a communication protocol. The CP 192 may be implemented, for example, in a SoC. According to an embodiment of the present disclosure, the CP 192 may perform at least a portion of the multimedia control function. The CP 192 may perform, for example, a distinction and authentication of the terminal within the communication network by using a subscriber identity module (SIM), e.g., a SIM card. In addition, the CP 192 may provide a service, such as a voice call, a video call, a text message, or packet data, to the user. In addition, the CP 192 may control the data transmission and reception of the wireless communication unit 140.

According to an embodiment of the present disclosure, the AP 191 or the CP 192 may load and process the command or data received from at least one of a respectively connected nonvolatile memory or another element of the electronic device 100 connected to a volatile memory. In addition, the AP 191 or the CP 192 may store data received from at least one of other element or generated by at least one of other element in a non-volatile memory.

Meanwhile, the electronic device 100 may further include configurations and/or elements that are not mentioned above, such as an ear jack, a GPS module, a vibration motor, an accessory, and the like. In this case, the accessory is a component of the electronic device 100 which can be detached from the electronic device 100, for example, a pen for a touch.

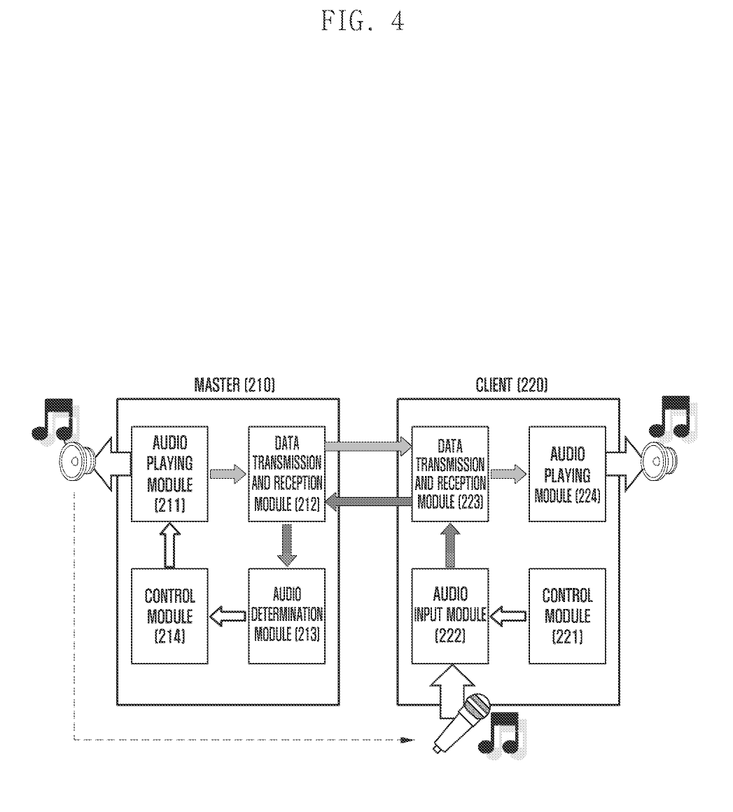

FIG. 4 is a block diagram of a multimedia content sharing play system according to an embodiment of the present disclosure.

Referring to FIG. 4, the multimedia content sharing play system according to various embodiments of the present disclosure may include a master multimedia content playing apparatus 210, which may also be referred to as a master electronic device, and a client multimedia content playing apparatus 220, which may also be referred to as a client electronic device. The master multimedia content playing apparatus 210 may be an electronic device having configurations which are described with reference to FIG. 3. The client multimedia content playing apparatus 220 may also be an electronic device having configurations which are described with reference to FIG. 3.

The master multimedia content playing apparatus 210 may include an audio playing module 211, a data transmission and reception module 212, an audio determination module 213, and a control module 214.

The audio playing module 211 may include an audio processing unit 150 (see FIG. 3) and at least one speaker, e.g., the first speaker SPK1 and the second speaker SPK2. That is, the audio playing module 211 may receive digital audio from the control module 214 and may convert the digital audio into analog audio, and then convert and output the analog audio as a sound wave. In addition, the audio playing module 211 may provide stereo, or in other words, stereo audio and/or stereo sound having more than one channel. For example, the audio processing unit 150 may convert a digital signal of a first channel into an analog audio to be output to the first speaker SPK1, and the first speaker SPK1 may convert and output the analog audio into a sound wave. The audio processing unit 150 may convert a digital signal of a second channel into an analog audio to be output to the second speaker SPK2, and the second speaker SPK2 may convert and output the analog audio into a sound wave. In addition, the audio playing module 211 may deliver the digital audio, e.g., the digital audio for the first channel, the second channel, or all channels, to the data transmission and reception module 212 under the control of the control module 214. In addition, under the control of the control module 214, the audio playing module 211 may play the digital audio of a channel from among multiple channels, that is two or more channels, and deliver the digital audio of another channel to the data transmission and reception module 212. Alternatively, the audio playing module 211 may deliver a control command for enabling the digital audio of the other channel to be played in the client multimedia content playing apparatus 220 to the data transmission and reception module 212.

The data transmission and reception module 212 may include a short range communication module (not shown). The data transmission and reception module 212 may receive audio characteristic information from the client multimedia content playing apparatus 220 and deliver the audio characteristic information to the audio determination module 213. In addition, the data transmission and reception module 212 may convert the digital audio received from the audio playing module 211 into a wireless frequency signal, or in other words, a radio frequency (RF) signal, to send the RF signal to the client multimedia content playing apparatus 220.

The audio determination module 213 may compare first audio characteristic information received from the data transmission and reception module 212 with second audio characteristic information of digital audio being played by the audio playing module 211 to calculate a degree of similarity. The audio determination module 214 may deliver the calculated degree of similarity to the control module 214.

The audio determination module 213 may calculate the degree of similarity for each channel and may deliver such information to the control module 214. For example, the audio determination module 213 may compare the first audio characteristics information with characteristic information of digital audio of the first channel to calculate a first channel similarity. In addition, the audio determination module 213 may compare the first audio characteristic information with characteristic information of digital audio of the second channel to calculate a second channel similarity. Such calculated similarities may be delivered to the control module 214 respectively.

The control module 214 may decide the sharing play by analyzing the degree of similarity received from the audio determination module 213. If the degree of similarity is equal to or greater than a set threshold value, the control module 214 may control the audio playing module 211 to deliver the digital audio to the data transmission and reception module 212. The audio determination module 213 and the control module 214 may be some configuration of and/or included in the processor, e.g., the AP 191, respectively.

The control module 214 may decide the sharing play, or in other words, may determine to execute the sharing play, by analyzing a plurality of similarities received from the audio determination module 213. In addition, when it is decided to share and play, the control module 214 may assign a playing channel to each apparatus. For example, if the degree of similarity of first channel is higher than the degree of similarity of second channel, and if the degree of similarity of first channel is equal to or greater than a set threshold value, the control module 214 may assign the first channel to the client multimedia content playing apparatus 220, and may assign the second channel to the master multimedia content playing apparatus 210. That is, the control module 214 may control the audio playing module 211 to transmit the digital audio of the first channel to the data transmission and reception module 212. In addition, the control module 214 may control the audio playing module 211 to play only the digital audio of the second channel.

The client multimedia content playing apparatus 220 may include a control module 221, an audio input module 222, a data transmission and reception module 223, and an audio playing module 224.

The control module 220 may receive a “sharing play command” from the user input module, e.g., the touch panel 111 or the key input unit 120 (see FIG. 3). In response to this, the control module 220 may operate the audio input module 222.

The audio input module 222 may include the microphone MIC and the audio processing unit 150. That is, the audio input module 222 may receive the sound wave and convert the received sound wave into an analog audio, convert the analog audio into a digital audio, sample the digital audio to extract the characteristic information, and deliver the characteristic information to the data transmission and reception module 223. In addition, after delivering the characteristic information, the operation of audio input module 222 may be terminated.

The data transmission and reception module 223 may include a short range communication module (not shown). The data transmission and reception module 223 may send a sharing play request message to the data transmission and reception module 212 of the master multimedia content playing apparatus 210. In this case, the sharing play request message may include audio characteristic information that the data transmission and reception module 223 received from the audio input module 222. The data transmission and reception module 223 may receive a RF signal as a response to a sharing play request, convert the RF signal into a digital audio, and deliver the digital audio to the audio playing module 224.

The audio playing module 224 may include an audio processing unit 150 (see FIG. 3) and at least one speaker, e.g., the first speaker SPK1 and the second speaker SPK2. That is, the audio playing module 224 may convert the digital audio data received from the data transmission and reception module 223 into an analog audio, and convert and output the analog audio into a sound wave.

The term “module” used in various embodiments of the present disclosure may refer to, for example, a “unit” including one of hardware, software, and firmware, or a combination of two or more thereof The term “module” may be interchangeable with a term such as a unit, a logic, a logical block, a component, or a circuit. The “module” may be a minimum unit of an integrated component or a part thereof The “module” may be a minimum unit for performing one or more functions or a part thereof The “module” may be mechanically or electronically implemented. For example, the “module” according to various embodiments of the present disclosure may include at least one of an application-specific integrated circuit (ASIC) chip, a field-programmable gate array (FPGA), and a programmable-logic device for performing operations which has been known or are to be developed hereinafter.

According to various embodiments of the present disclosure, an electronic device may include at least one speaker, a microphone, an audio processing unit to convert a digital audio into an analog audio and output to the at least one speaker, and to convert the analogue audio received from the microphone into a digital audio, at least one processor to control the at least one speaker and the audio processing unit, and a data transmission and reception module for data communication with an external device, wherein the at least one processor controls to transmit a sharing play request message including characteristic information of an audio received through the microphone and the audio processing unit to the external device by using the data transmission and reception module, and play received multimedia content, from the external device, as a response to the sharing play request message. The at least one processor selects at least one audio channel corresponding to the characteristic information among a plurality of channels when the audio is a stereo audio including the plurality of channels, and transmits at least one of at least a portion corresponding to the selected channel among the multimedia content, or information related with the selected channel to the external device. The at least one processor calculates a degree of similarity between characteristic information of at least one channel of the stereo audio and the received characteristic information, when the audio is the stereo audio including a plurality of channels, as at least a portion of the result of the comparison, and selects at least one channel corresponding to the received characteristic information comprises selecting at least one channel corresponding to the received characteristic information among the plurality of channels, based on the degree of similarity. The at least one processor controls to play an audio of a channel corresponding to a low degree of similarity among a first degree of similarity between characteristic information of a first channel of the stereo audio and the received characteristic information and a second degree of similarity between characteristic information of a second channel of the stereo audio and the received characteristic information.

According to various embodiments of the present disclosure, an electronic device may include at least one speaker, a microphone, an audio processing unit to convert a digital audio into an analog audio and output to the at least one speaker, and to convert the analogue audio received from the microphone into a digital audio, at least one processor to control the at least one speaker and the audio processing unit, and a data transmission and reception module for data communication with an external device, wherein the at least one processor controls to transmit a sharing play request message including characteristic information of an audio received through the microphone and the audio processing unit to the external device by using the data transmission and reception module, and to play received multimedia content, from the external device, as a response to the sharing play request message. The at least one processor controls to receive, as at least a portion of the multimedia content, audio data of at least one channel among multiple channels of stereo audio, and to play an audio of the at least one channel, based on the audio data. The at least one processor terminates an operation of the microphone in response to the reception of the audio through the microphone and the audio processing unit. The electronic device further includes a user input module, wherein the at least one processor operates the microphone when receiving a sharing play command through the user input module.

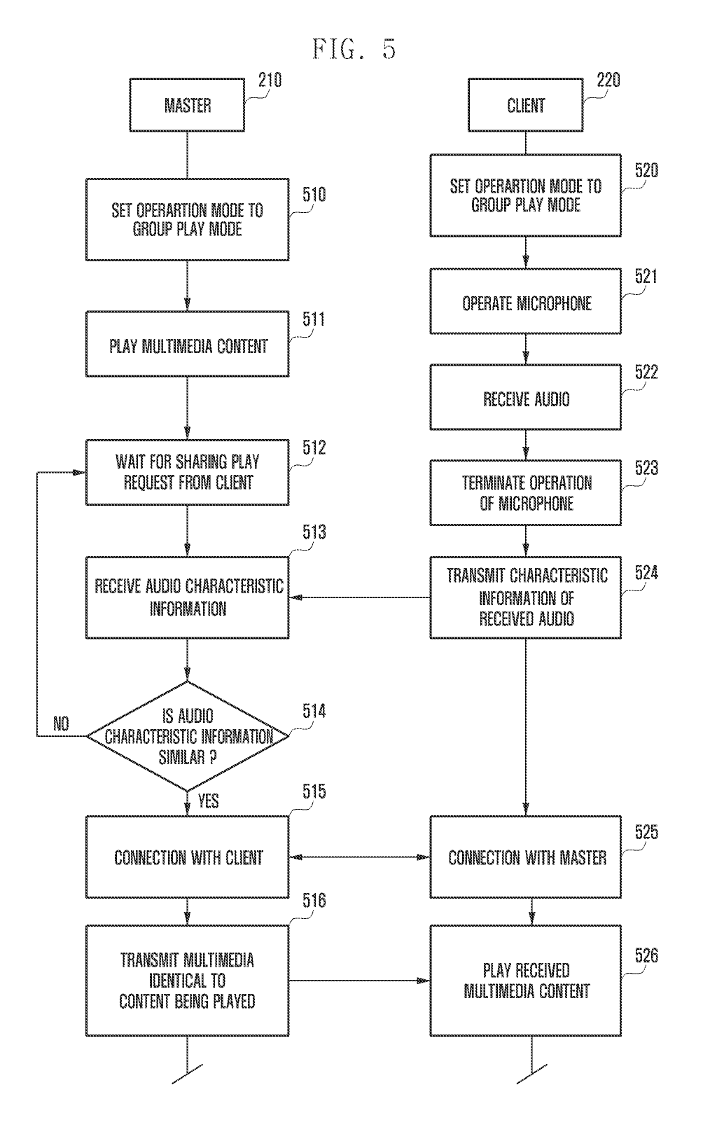

FIG. 5 is a flowchart for explaining a method for sharing and playing multimedia content according to an embodiment of the present disclosure.

Referring to FIG. 5, a configuration of system to implement the method for sharing and playing multimedia content may include a master multimedia content playing apparatus 210, which may also be referred to as a master 210, and a client multimedia content playing apparatus, 220, which may also be referred to as a client 220. In the following example of FIG. 5, a single one of the client 220 may be involved in the sharing play. If the master 210 can be connected with various devices simultaneously, other electronic devices may also be involved in the sharing play. For example, the master 220 may be provided with a short range communication module supporting Wi-Fi Direct. The short range communication module may communicate with a first client through a first frequency band and may communicate with a second client through a second frequency band.

The master 210 may receive a sharing play command from user through a user input module, e.g., a touch panel or a key input. At operation 510, in response to the received sharing play command, the master 210 may set a multimedia content play operation mode to a group play mode, which may also be referred to as a master mode or an Access Point (AP) mode. At operation 511, the master 210 may play the multimedia content. In this case, the user input for the audio play may be a separate input different from the sharing play command. That is, the master 21 may set the operation mode to the group play mode in response to the sharing play command in operation 510, and may play the audio of pertinent multimedia content in response to the selection of a folder to play, a file or a list, in operation 511. While playing the audio, at operation 512, the master 210 may wait until the sharing play is requested from other electronic device, e.g., the client 220. At operation 513, the master 210 may receive audio characteristic information from the client 220. At operation 514, the master 210 may determine whether the audio characteristic information of the multimedia content being played is similar to the audio characteristic information received from the client 220. When it is not similar, the process of the master 210 may be returned to operation 512. When it is similar, at operation 515, the master 210 may perform a process of connection with the client 220, e.g., the master 210 may execute and/or perform a connection process of Bluetooth technology, a connection process of Wi-Fi Direct technology, or any other similar and/or suitable connection process to establish a communication connection between the master 210 and the client 220. In this case, the connection process may include a process in which the master 210 transmits a sharing play approval message to the client 220. When the connection is established, at operation 516, the master 210 may transmit the multimedia content that is identical with the multimedia content being played to the client 220. For example, the master 210 may transmit the multimedia content while playing. Meanwhile, the master 210 may determine whether the audio is a stereo audio including a plurality of channels, and, when the audio is the stereo audio, it is possible to allocate a different channel to itself, i.e., the master 210, and the client 220, respectively. An example of such allocation method was described above. According to the above described method, the master 210 may play the audio of the first channel, and may simultaneously transmit the audio of the second channel to the client 220.

Meanwhile, the client 220 may receive a “sharing play command” from a user through a user input module. At operation 520, in response to the sharing play command, the client 220 may set the multimedia content play operation mode to the group play mode, or alternatively, to a client mode or a sub-mode. In response to this, at operation 521, the client 220 may operate the microphone. Accordingly, at operation 522, the client 220 may receive audio from the microphone. When the audio is received, at operation 523, the client 220 may terminate the operation of the microphone. At operation 524, the client 220 may transmit the characteristic information of the received audio to the master 210. In this case, the operation 524 may include an operation of searching for at least one adjacent electronic device by using the short range communication module included in the client 220, and an operation of transmitting the characteristic information to the master 210, which operates in the group play mode, the master mode, or the AP mode, from among at least one searched electronic device. At operation 525, the client 220 may perform the process of establishing a connection with the master 210. In this case, although not shown in FIG. 5, the connection process may include an operation of receiving a sharing play approval message. When the connection is established, the client 220 may be able to receive the multimedia content from the master 210, and then, at operation 526, the client 220 may play the received multimedia content.

According to various embodiments of the present disclosure, the master 210 may receive a message including the audio characteristic information and time information, e.g., a point of time when the client 220 receives the audio, from the client 220. The master 210 may determine the point of time, which may also be referred to as a time, of playing the audio that the client 220 received by using the time information received from the client 220. For example, if the reception time of the message is ‘t1’, and the time information included in the message is ‘t2’, the master 210 may calculate a difference value between the two such that t3=(t1−t2). If the current play time of the audio is t4, the master 210 may determine whether the audio characteristic information of the multimedia content played at t5, wherein t5=(t4−t3), is similar to the audio characteristic information received from the client 220.

According to various embodiments of the present disclosure, the client 220 may transmit the audio to the master 210 in the form of a raw data. Then, the master 210 may process the raw data into, for example, a fingerprint that includes less data than included in the raw data and that uniquely identifies the raw data. The master 210 may compare the fingerprint with the characteristic information of the audio that is currently playing, and determine the similarity between the two.

According to various embodiments of the present disclosure, the client 220 may process the raw data into the fingerprint and transmit the finger print to the master 210. Then, the master 210 may compare the fingerprint received from the client 220 with the characteristic information of the audio that is currently playing, and determine the similarity between the two.

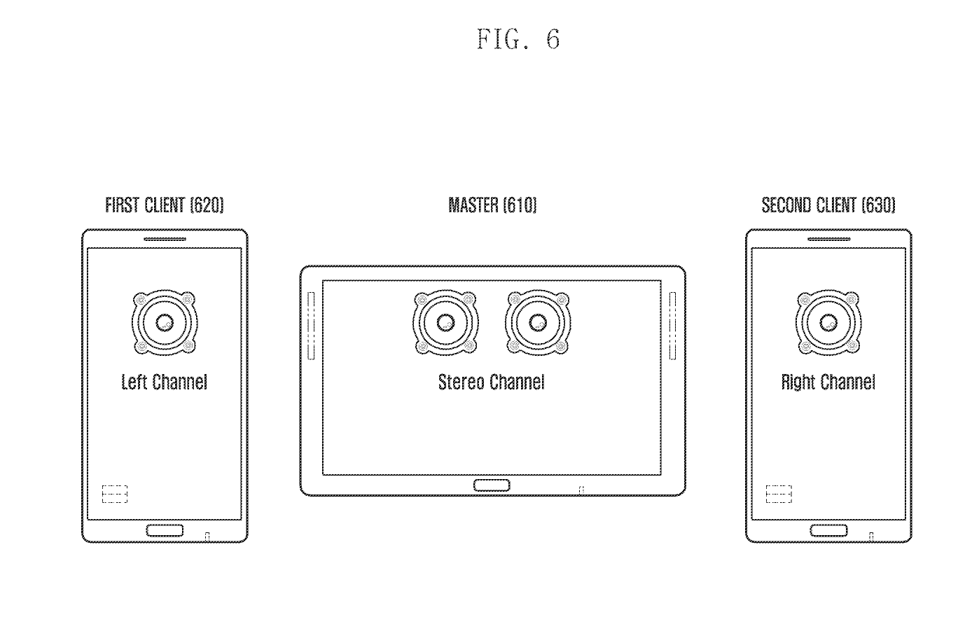

FIG. 6 is a diagram for explaining a method for sharing and playing multimedia content in a situation in which clients are respectively disposed on either side of a master according to an embodiment of the present disclosure.

Referring to FIG. 6, a first client 620 may be disposed on a left side of a master 610 and a second client 630 may be disposed on a right side of the master 610. In this case, audio of multimedia content being played on the master 610 may be stereo audio. The master 610 may receive audio characteristic information, e.g., a waveform, hereinafter, referred to as a first reception waveform, from the first client 620. The master 610 may calculate a degree of similarity, hereinafter, referred to as a first-first degree of similarity, by comparing the first reception waveform with a waveform of a left channel of the stereo audio being played. In addition, the master 610 may calculate a degree of similarity, hereinafter, referred to as a first-second degree of similarity, by comparing the first reception waveform with a waveform of the right channel. The master 610 may determine that the first-first degree of similarity is higher than the first-second degree of similarity, and, accordingly, may transmit the audio of the left channel to the first client 620. In addition, the master 610 may receive audio characteristic information, e.g., a waveform, hereinafter, referred to as a second reception waveform, from the second client 630. The master 610 may calculate a degree of similarity, hereinafter, referred to as a second-first degree of similarity, by comparing the second reception waveform with the waveform of the left channel of the stereo audio being played. In addition, the master 610 may calculate a degree of similarity, hereinafter, referred to as a second-second degree of similarity, by comparing the second reception waveform with the waveform of the right channel. The master 610 may determine that the second-second degree of similarity is higher than the second-first degree of similarity, and accordingly, may transmit the audio of the right channel to the second client 630. Accordingly, the master 610 may transmit the audio of the left channel to the first client 620 and transmit the audio of the right channel to the second client 630, while playing the stereo audio.

The determination of the degree of similarity of the audio is not limited to the comparison of the waveform, and may be performed by various methods based on various characteristic information, e.g., an audio fingerprint, of audio.

According to various embodiments of the present disclosure, the master 610 may transmit the same stereo audio to the first client 620 and the second client 630. In addition, the master 610 may transmit a command for designating a channel to play to each client. For example, the first client 620 may play the left channel of the stereo audio according to the command of the master 610, and the second client 630 may play the right channel of the stereo audio according to the command of the master 610.

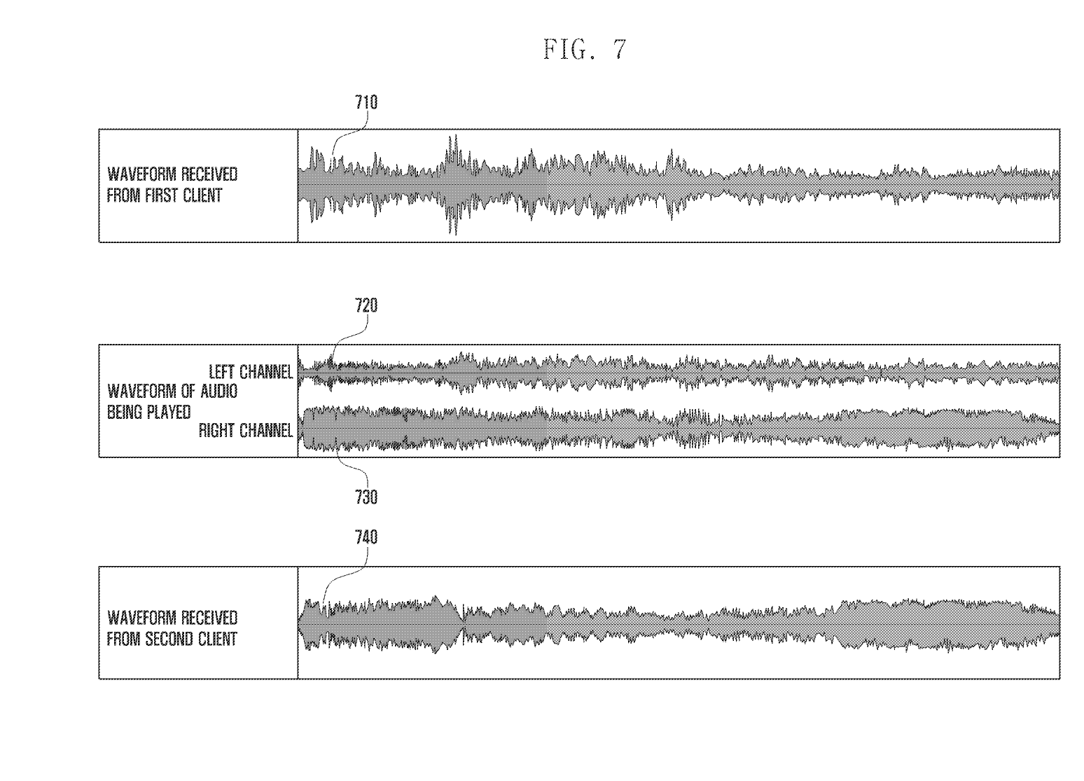

FIG. 7 is a diagram for explaining a process of determining a degree of similarity for a left channel and a right channel of a stereo audio according to an embodiment of the present disclosure.

Referring to FIG. 7, a first client may be disposed in a left side of the master and a second client may be disposed on a right side of the master. In this case, audio of multimedia content being played in the master may be stereo audio. The master may receive audio characteristic information, for example, a first waveform 710, from the first client. The master may calculate the a first-first degree of similarity by comparing the first waveform 710 with a second waveform 720 of the left channel of stereo audio being played. In addition, the master may calculate a first-second degree of similarity by comparing the first waveform 710 with a third waveform 730 of the right channel. The master may determine that the first-first degree of similarity is higher than the first-second degree of similarity, and thus may transmit the audio of the left channel to the first client. In addition, the master may receive audio characteristic information, for example, a fourth waveform 740, from the second client. The master may calculate a second-first degree of similarity by comparing the fourth waveform 740 with the second waveform 720. In addition, the master may calculate a second-second degree of similarity by comparing the fourth waveform 740 with the third waveform 730. The master may determine that the second-second degree of similarity is higher than the second-first degree of similarity, and thus may transmit the audio of the right channel to the second client.

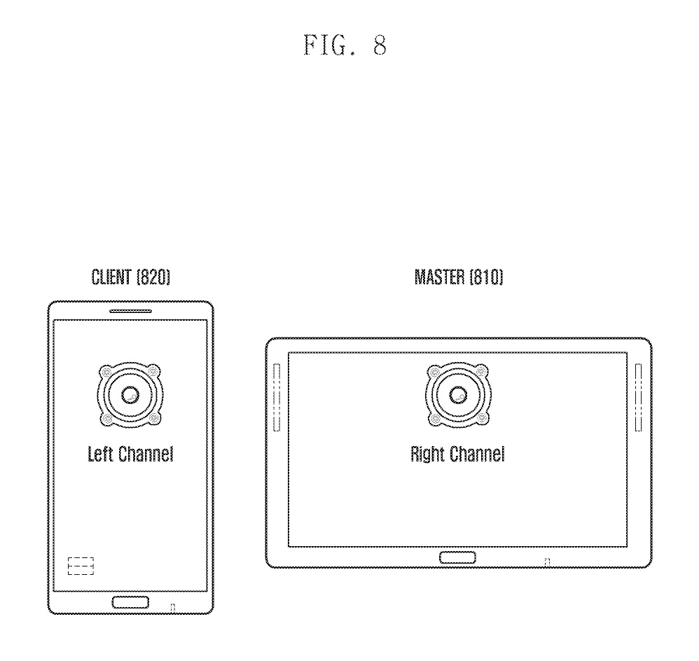

FIG. 8 is a diagram for explaining a method for sharing and playing multimedia content in a situation in which a single client is disposed in the left side of the master according to an embodiment of the present disclosure.

Referring to FIG. 8, a client 820 may be disposed in a left side of a master 810. In this case, audio being played in the master 810 may be a stereo audio. The master 810 may receive audio characteristic information, e.g., at least one of a frequency, a waveform, a wave height, and/or amplitude, from the client 820. The master 810 may calculate a first degree of similarity by comparing the audio characteristic information received from the client 820 with characteristic information of a left channel of stereo audio being played. In addition, the master 810 may calculate a second degree of similarity by comparing the audio characteristic information received from the client 820 with characteristic information of the right channel. As a result of the comparison, if the first degree of similarity is higher than the second degree of similarity, and the first degree of similarity is higher than a set threshold value, the master 810 may determine that the client 820 is disposed in the left side of the master 810. According to this determination, the master 810 may play only the audio of the right channel, for example, play the same audio, that is, audio of the right channel, through both a left speaker and a right speaker, and may transmit audio of the left channel to the client 820 simultaneously.

According to various embodiments of the present disclosure, the master 810 may transmit a command for designating a channel to play together with the stereo audio to the client 820. For example, the master 810 may play the right channel of the stereo audio, and the client 820 may play the left channel of the stereo audio according to the command of the master 810.

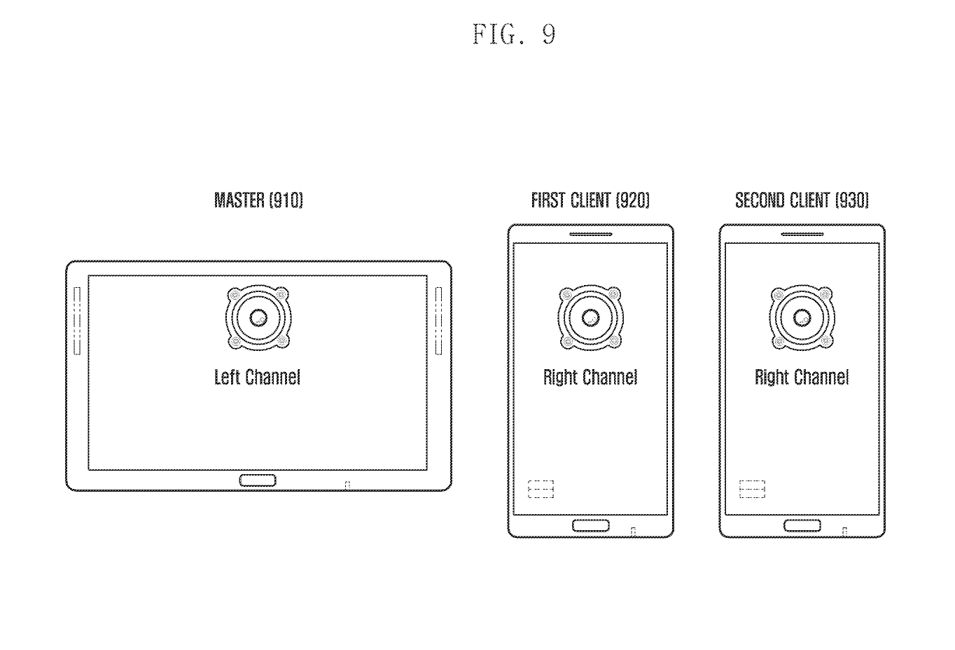

FIG. 9 is a diagram for explaining a method for sharing and playing multimedia content in a situation in which two clients are disposed in the right side of the master according to an embodiment of the present disclosure.

Referring to FIG. 9, a first client 920 and a second client 930 may be disposed in a right side of a master 910. Audio being played in the master 910 may be a stereo audio. The master 910 may receive audio characteristic information, e.g., at least one of a frequency, a waveform, a wave height, and/or an amplitude from the client 920 and the client 930 respectively.

The master 910 may receive the audio characteristic information, which may be referred to as first characteristic information, from the first client 920. The master 910 may calculate a third-first degree of similarity by comparing the first characteristic information with characteristic information of the left channel of stereo audio being played. In addition, the master 910 may calculate a third-second degree of similarity by comparing the first characteristic information with characteristic information of the right channel. The master 910 may determine that the third-second degree of similarity is higher than the third-first degree of similarity. In addition, the master 910 may receive audio characteristic information, that is second characteristic information, from the second client 930. The master 910 may calculate a fourth-first degree of similarity by comparing the second characteristic information with the characteristic information of the left channel of stereo audio being played. In addition, the master 910 may calculate a fourth-second degree of similarity by comparing the second characteristic information with the characteristic information of the right channel. The master 910 may determine that the fourth-second degree of similarity is higher than the fourth-first degree of similarity. According to the result of the determination, the master 910 may determine that the first client 920 and the second client 930 are disposed in the right side of the master 910. According to such determination, the master 910 may play the audio of the left channel, and may transmit the audio of the right channel to the client 920 and the client 930 simultaneously.

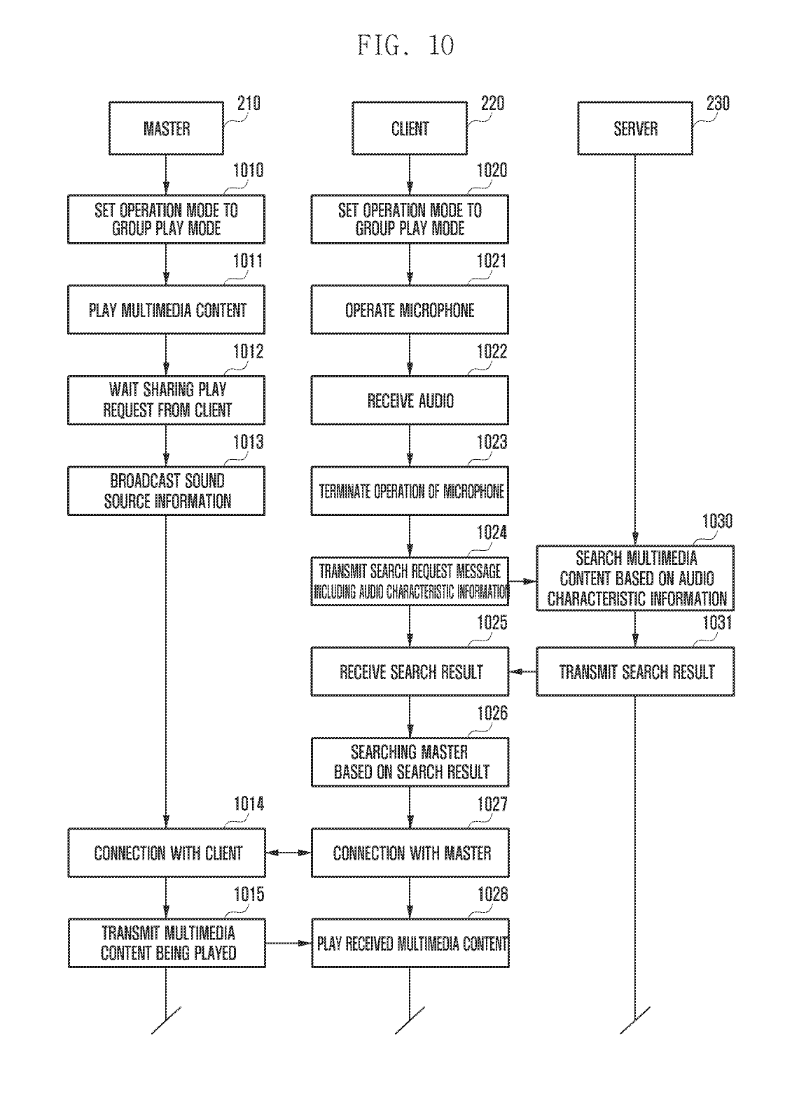

FIG. 10 is a flowchart for explaining a method for sharing and playing multimedia content according to various embodiments of the present disclosure.

Referring to FIG. 10, at operation 1010, a master 210 may set a multimedia content play operation mode to a group play mode. At operation 1011, the master 210 may play multimedia content. At operation 1012, the master 210 may wait until a sharing play is requested from another electronic device, e.g., a client 220. At operation 1013, the master 210 may broadcast sound source information, e.g., a title, a size, etc., for the multimedia content being played. For example, the master 210 may broadcast a beacon frame including the sound source information. A communication protocol of the beacon frame may be a Wi-Fi protocol and/or any other similar and/or suitable communication protocol. At operation 1014, the master 210 may perform a process of connection, e.g., may establish a communication connection, with the client 220. In this case, the connection process may include a process of receiving a sharing play request message from the client 220 by the master 210. When the connection is established, at operation 1015, the master 210 may transmit the same multimedia content as the multimedia content being played by the master 210 to the client 220.

Meanwhile, at operation 1020, the client 220 may set the multimedia content play operation mode to the group play mode. If the multimedia content play operation mode is set to the group play mode, at operation 1021, the client 220 may operate the microphone. Accordingly, at operation 1022, the client 220 may receive the audio from the microphone. When the audio is received, at operation 1023, the client 220 may terminate the operation of the microphone. At operation 1024, the client 220 may transmit a search request message including characteristic information of the received audio to another electronic device, e.g., a server 230. In response to this, at operation 1030, the server 230 may search multimedia content in a database based on the audio characteristic information received from the client 220. At operation 1031, the server 230 may transmit a response message including the search result, e.g., sound source information, to the client 220.

At operation 1025, the client 220 may receive a response message from the server 230. At operation 1026, the client 220 may perform a process of searching the master 210 based on the search result. For example, the client 220 may compare the broadcasted sound source information with the sound source information received from the server 230, and may decide the master 210 as, or in other words, determine the master 201 to be, an electronic device that plays the multimedia content corresponding to the audio characteristic information. At operation 1027, the client 220 may perform the process of connection with the master 210. In this case, the connection process may include a process of transmitting a sharing play request message to the master 210 by the client 220. When the connection is established, the client 220 shall receive the multimedia content from the master 210. Then, at operation 1028, the client 220 may play the received multimedia content.

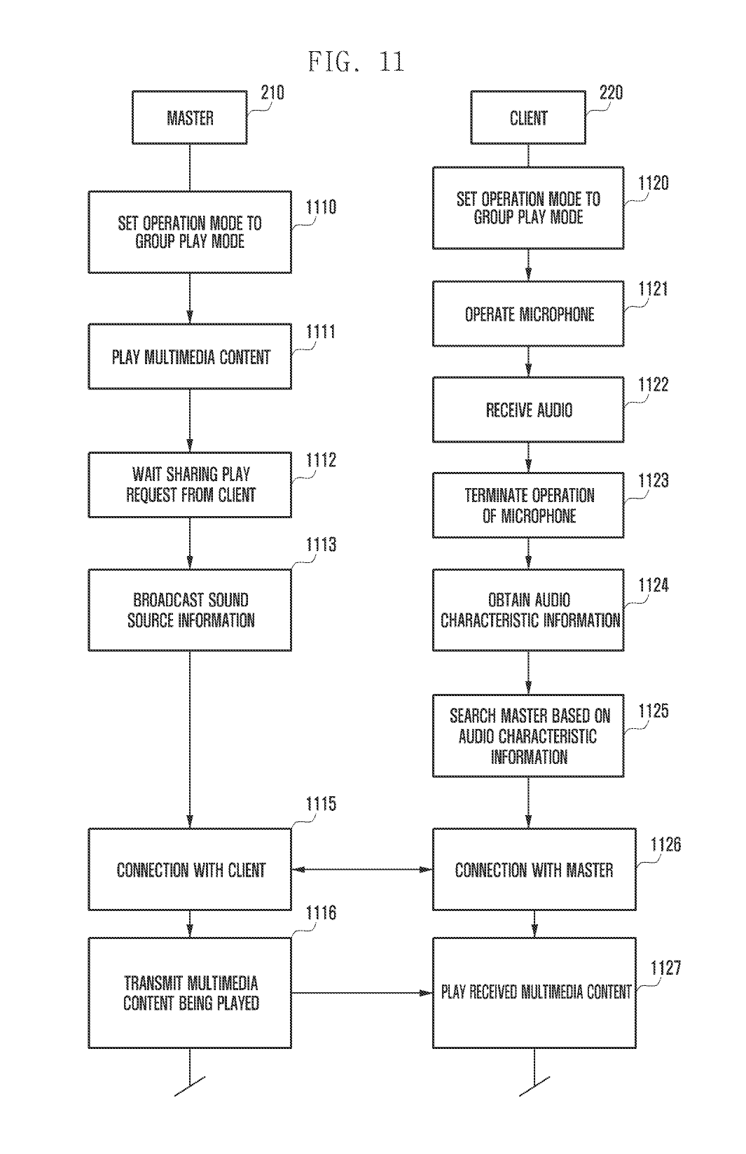

FIG. 11 is a flowchart for explaining a method for sharing and playing multimedia content according to various embodiments of the present disclosure.

Referring to FIG. 11, at operation 1110, a master 210 may set a multimedia content play operation mode to a group play mode. At operation 1111, the master 210 may play multimedia content. At operation 1112, the master 210 may wait until a sharing play is requested from other electronic device, e.g., a client 220. At operation 1113, the master 210 may broadcast sound source information, e.g., an audio fingerprint, for the multimedia content being played. At operation 1114, the master 210 may perform the process of connection with the client 220. In this case, the connection process may include a process of the master 210 receiving a sharing play request message from the client 220. When the connection is established, at operation 1115, the master 210 may transmit multimedia content that is the same as the multimedia content being played by the master 210 to the client 220.

Meanwhile, at operation 1120, the client 220 may set the multimedia content play operation mode to the group play mode. If the multimedia content play operation mode is set to the group play mode, at operation 1121, the client 220 may operate the microphone. Accordingly, at operation 1122, the client 220 may receive the audio from the microphone. When the audio is received, at operation 1123, the client 220 may terminate the operation of the microphone. At operation 1124, the client 220 may obtain audio characteristic information from the received audio. At operation 1125, the client 220 may perform a process of searching the master 210 based on the audio characteristic information. For example, the client 220 may determine an electronic device that broadcasted the audio fingerprint identical with, or similar to, the obtained audio characteristic information as the master 220. At operation 1126, the client 220 may perform the process of connection with the master 210. In this case, the connection process may include a process of the client 220 transmitting a sharing play request message to the master 210. When the connection is established, the client 220 shall receive the multimedia content from the master 210. Then, at operation 1127, the client 220 may play the received multimedia content.

The operations that are performed in the above mentioned drawings, e.g., FIGS. 5 to 11, may be executed by a sequential, a parallel, an iterative, or a heuristic method. In addition, some operations may be executed in a different order, or omitted, or may add other operation.

According to various embodiments of the present disclosure, a playing method for an electronic device may include playing multimedia content, receiving characteristic information from an external device, comparing the received characteristic information with characteristic information of an audio of the multimedia content, determining whether to perform a sharing play of the multimedia content based on a result of the comparison, and transmitting at least a portion of the multimedia content to the external device when it is determined to perform the sharing play of the multimedia content. Determining whether to perform a sharing play of the multimedia content includes selecting at least one channel corresponding to the received characteristic information among a plurality of channels when the audio is a stereo audio including the plurality of channels, and transmitting at least a portion of the multimedia content comprises transmitting at least one of at least a portion corresponding to the selected channel among the multimedia content, or information related with the selected channel to the external device. Comparing the received characteristic information includes calculating a degree of similarity between characteristic information of at least one channel of the stereo audio and the received characteristic information, when the audio is the stereo audio including a plurality of channels, as at least a portion of the result of the comparison, and selecting at least one channel corresponding to the received characteristic information comprises selecting at least one channel corresponding to the received characteristic information among the plurality of channels, based on the degree of similarity. Transmitting at least a portion of the multimedia content includes playing an audio of a different channel from the selected channel among the multimedia content. Playing an audio of a different channel includes playing an audio of a channel corresponding to a low degree of similarity among a first degree of similarity between characteristic information of a first channel of the stereo audio and the received characteristic information and a second degree of similarity between characteristic information of a second channel of the stereo audio and the received characteristic information.

According to various embodiments of the present disclosure, a playing method for an electronic device may include receiving an audio through the microphone, transmitting a sharing play request message including characteristic information of the received audio to a first external device, receiving multimedia content related with the received audio from the first external device, in response to the sharing play request message, and playing the received multimedia content. Receiving multimedia content related with the received audio includes receiving an audio data of at least one channel among a plurality of channels of a stereo audio from the first external device. The playing method further includes terminating an operation of the microphone in response to the reception of the audio. The playing method further includes operating the microphone when receiving a sharing play command through a user input module. The playing method further includes receiving sound source information from the first external device, and determining whether to transmit the sharing play request message based on the sound source information. Determining whether to transmit the sharing play request message includes transmitting the characteristic information to a second external device, receiving a search result of multimedia content corresponding to the characteristic information from the second external device, and determining whether to transmit the sharing play request message by comparing the search result with the sound source information.

The foregoing method according to various embodiments of the present disclosure may be implemented in a program command form executable by various computer means and be recorded in a computer readable recording medium. In this case, the computer readable recording medium may include a program command, a data file, and a data structure individually or a combination thereof In the meantime, the program command recorded in a recording medium may be specially designed or configured for the present disclosure or be known to a person having ordinary skill in a computer software field to be used. The computer readable recording medium includes Magnetic Media such as hard disk, floppy disk, or magnetic tape, optical media such as compact disc read only memory (CD-ROM) or a DVD, magneto-optical media such as floptical disk, and a hardware device such as ROM. RAM, or flash memory for storing and executing program commands. Further, the program command includes a high-level language code executable by a computer using an interpreter as well as a machine language code created by a compiler.

According to various embodiments of the present disclosure, there is provided a computer-readable recording medium storing a program for playing multimedia content in an electronic device, wherein the program performs playing multimedia content, receiving characteristic information from an external device, comparing the received characteristic information with characteristic information of audio of the multimedia content, determining whether to perform a sharing play of the multimedia content based on a result of the comparison, and transmitting at least a portion of the multimedia content to the external device when it is determined to perform the sharing play of the multimedia content.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A playing method for an electronic device, the method comprising:
playing multimedia content including audio;
receiving characteristic information from an external device;
comparing the received characteristic information with characteristic information of the audio of the multimedia content;
determining whether to perform a sharing play of the multimedia content based on a result of the comparing of the received characteristic information; and
transmitting at least one portion of the multimedia content to the external device upon determining to perform the sharing play of the multimedia content.

2. The method of claim 1,
wherein the determining of whether to perform the sharing play of the multimedia content comprises selecting at least one channel corresponding to the received characteristic information from among a plurality of channels when the audio of the multimedia content is stereo audio including the plurality of channels; and
wherein the transmitting of the at least one portion of the multimedia content comprises transmitting at least one of at least one portion corresponding to the selected channel from among the multimedia content, or information related with the selected at least one channel to the external device.

3. The method of claim 2,
wherein the comparing of the received characteristic information comprises:
calculating a degree of similarity between characteristic information of at least one channel of the stereo audio and the received characteristic information; and,
when the audio is the stereo audio including a plurality of channels, determining the calculated degree of similarity to be at least one portion of the result of the comparison, and
wherein the selecting of the at least one channel corresponding to the received characteristic information comprises selecting at least one channel corresponding to the received characteristic information from among the plurality of channels based on the degree of similarity.

4. The method of claim 2, wherein the transmitting of the at least one portion of the multimedia content comprises playing an audio of a different channel from the selected channel from among the multimedia content.

5. The method of claim 4, wherein the playing of the audio of the different channel comprises playing an audio of a channel corresponding to a low degree of similarity from among a first degree of similarity between characteristic information of a first channel of the stereo audio and the received characteristic information and a second degree of similarity between characteristic information of a second channel of the stereo audio and the received characteristic information.

6. The method of claim 1, wherein the received characteristic information and the characteristic information of the audio of the multimedia content respectively comprise at least one of a frequency, a waveform, a wave height, or an amplitude of the audio.

7. A playing method for an electronic device having a microphone, the method comprising:
receiving audio through the microphone;
transmitting a sharing play request message including characteristic information of the received audio to a first external device;
receiving multimedia content related with the received audio from the first external device in response to the sharing play request message; and
playing the received multimedia content.

8. The playing method of claim 7, wherein the receiving of the multimedia content related with the received audio comprises receiving audio data of at least one channel from among a plurality of channels of a stereo audio from the first external device.

9. The method of claim 7, further comprising terminating an operation of the microphone in response to the receiving of the audio through the microphone.

10. The method of claim 7, further comprising operating the microphone upon receiving a sharing play command through a user input module.

11. The method of claim 7, further comprising:
receiving sound source information from the first external device; and
determining whether to transmit the sharing play request message based on the sound source information.

12. The method of claim 11, wherein the determining of whether to transmit the sharing play request message comprises:
transmitting the characteristic information to a second external device;
receiving a search result of multimedia content corresponding to the characteristic information from the second external device; and
determining whether to transmit the sharing play request message by comparing the search result with the sound source information.

13. An electronic device comprising:
at least one speaker;
an audio processing unit configured to convert a digital audio into an analog audio and to output the analog audio to the at least one speaker;
at least one processor configured to control the at least one speaker and the audio processing unit so as to play the digital audio; and
a data transmission and reception module configured to perform data communication with an external device,
wherein the at least one processor is further configured to:
compare received characteristic information that is received from the external device with characteristic information of audio of multimedia content being played through the at least one speaker;
determine whether to perform a sharing play of the multimedia content based on a result of the comparing of the received characteristic information; and
transmit at least one portion of the multimedia content to the external device upon determining to perform the sharing play of the multimedia content.

14. The electronic device of claim 13, wherein the at least one processor is further configured to:
select at least one audio channel corresponding to the characteristic information from among a plurality of channels when the audio of the multimedia content is a stereo audio including the plurality of channels; and
transmit at least one of the at least one portion corresponding to the selected at least one audio channel from among the multimedia content, or information related with the selected channel to the external device.

15. The electronic device of claim 13, wherein the at least one processor is further configured to:
calculate a degree of similarity between characteristic information of at least one channel of the stereo audio and the received characteristic information;
when the audio is the stereo audio including a plurality of channels, determine the calculated degree of similarity to be at least one portion of the result of the comparison; and
select at least one channel corresponding to the received characteristic information by selecting at least one channel corresponding to the received characteristic information from among the plurality of channels based on the degree of similarity.

16. The electronic device of claim 15, wherein the at least one processor is further configured to:
play an audio of a channel corresponding to a low degree of similarity from among a first degree of similarity between characteristic information of a first channel of the stereo audio and the received characteristic information and a second degree of similarity between characteristic information of a second channel of the stereo audio and the received characteristic information.

17. An electronic device comprising:
at least one speaker;
a microphone;
an audio processing unit configured to convert a digital audio into an analog audio, to output the analog audio to the at least one speaker, and to convert the analog audio received from the microphone into a digital audio;
at least one processor configured to control the at least one speaker and the audio processing unit; and
a data transmission and reception module configured to perform data communication with an external device,
wherein the at least one processor is further configured to:
transmit a sharing play request message including characteristic information of an audio received through the microphone and the audio processing unit to the external device by using the data transmission and reception module; and
play received multimedia content, from the external device, as a response to the sharing play request message.

18. The electronic device of claim 17, wherein the at least one processor is further configured to:
receive, as at least one portion of the multimedia content, audio data of at least one channel from among multiple channels of stereo audio; and
play an audio of the at least one channel based on the audio data.

19. The electronic device of claim 17, wherein the at least one processor is further configured to terminate an operation of the microphone in response to the reception of the audio through the microphone and the audio processing unit.

20. The electronic device of claim 17, further comprising a user input module,
wherein the at least one processor is further configured to operate the microphone when receiving a sharing play command through the user input module.

21. A computer readable recording medium storing a program for playing multimedia content in an electronic device, the program performing:
playing multimedia content;
receiving characteristic information from an external device;
comparing the received characteristic information with characteristic information of audio of the multimedia content;
determining whether to perform a sharing play of the multimedia content based on a result of the comparing of the received characteristic information; and
transmitting at least one portion of the multimedia content to the external device when it is determined to perform the sharing play of the multimedia content.
